(19) United States
(12) Patent Application Publication
(10) Pub. No.: US 2021/0334895 A1
(43) Pub. Date: Oct. 28, 2021

(54) SYSTEM AND METHOD FOR COLLECTING AND STORING ENVIRONMENTAL DATA IN A DIGITAL TRUST MODEL, AND PROCESSING THE DATA USING AN ACCOUNTING INFRASTRUCTURE

(71) Applicant: KPMG LLP, New York, NY (US)

(72) Inventors: Venki KUMAR, Boston, MA (US); Shekar ATMAKUR, Atlanta, GA (US); Salvatore Joseph TERNULLO, Medford, MA (US); Padmini Ashok KUMAR, Boston, MA (US)

(21) Appl. No.: 17/239,420

(22) Filed: Apr. 23, 2021

Related U.S. Application Data
(60) Provisional application No. 63/087,721, filed on Oct. 5, 2020.
(60) Provisional application No. 63/015,135, filed on Apr. 24, 2020.

(51) Int. Cl. G06Q 40/00; H04L 9/06; G06N 20/00; G06Q 10/04

(52) U.S. Cl. CPC G06Q 40/00; H04L 9/0643; H04L 2209/38; G06Q 10/04; G06N 20/00

(57) ABSTRACT

A data collection and processing system that aggregates data, such as for example environmental data, and then stores the data along with additional information in an immutable and trusted manner, such as for example by employing blockchain technology. The additional information stored in the blockchain can include third party data, the types of risk models and machine learning techniques employed by the system, as well as the data outputted from an enrichment or cognitive intelligence unit.

### RELATED APPLICATIONS

The present application claims priority to U.S. provisional patent application Ser. No. 63/087,721, filed on Oct. 5, 2020, and entitled SYSTEM AND METHOD FOR COLLECTING AND STORING ENVIRONMENTAL DATA IN A DIGITAL TRUST MODEL, AND PROCESSING THE DATA USING AN ACCOUNTING INFRASTRUCTURE, and further claims priority to U.S. provisional patent application Ser. No. 63/015,135, filed on Apr. 24, 2020, and entitled SYSTEM AND METHOD FOR COLLECTING AND STORING ENVIRONMENTAL DATA IN A DIGITAL TRUST MODEL, AND PROCESSING THE DATA USING AN ACCOUNTING INFRASTRUCTURE, the contents of which are herein incorporated by reference.

### BACKGROUND OF THE INVENTION

Today more than ever, there is enhanced focus on the environment and the impact that humans are having thereon. There has been an ever growing body of scientific research and data indicating that humans are having a dramatic impact on the climate of the Earth, and unfortunately are changing the climate for the worse. Climate change typically occurs when changes in Earth's overall climate system result in new weather patterns that remain in place for extended periods of time. The climate system of the Earth is related to the amount of energy entering the overall climate system, such as from the Sun and green-house gas emissions, and the total amount of energy leaving the system, such as into space. Today, the amount of energy being retained in the climate system continues to increase, thus leading to an overall increase in the temperature of the Earth.

The Earth's climate is one of the few aspects of life that are shared universally amongst humans. In the midst of increasingly severe and frequent climate impacts, governments and enterprises alike are becoming increasingly aligned regarding the need to manage climate change by reducing global green-house gas emissions across private and public sectors. Moreover, climate change has become a ubiquitous factor in our overall human experience. Global experts are virtually unified in agreement that urgent action needs to be taken to reduce emissions in order to help manage the overall impacts on the environment.

Prior actions taken on behalf of governments, enterprises such as companies, and individuals have resulted in increased awareness of the carbon foot-print associated with everyday activities. This awareness has led some enterprises to put efforts in place to measure their carbon emissions in order to monitor and even improve upon their current footprint. Both enterprises and individuals can, if needed, buy and sell carbon “offsets” for these emissions. However, to date, there has not been an overall system in place that allows people to readily track environmental information or data associated with specific activities with a high degree of confidence and in a trusted and verifiable manner. That is, although the environmental data can be collected, it is typically not secured in an immutable format and hence can be subjected to unwanted changes and manipulations. As such, it has been difficult to rely on the collected environmental information when making long term plans and overall decisions based on the data.

One such scenario involves the ability to utilize the environmental data in a financial environment, such as for example in a tax, audit, accounting or consulting environment, by financial entities when advising clients about long term financial and business strategies. Unfortunately, current building management systems do not secure the environmental data in an immutable and trusted manner for subsequent verification. Further, the unsecured nature of the environmental data makes it difficult for the financial entities to rely on the data when performing standard financial activities on behalf of their clients, such as for example advising the clients on overall business strategy.

### SUMMARY OF THE INVENTION

The present invention is directed to a data collection and processing system that aggregates data, such as for example environmental data, and then stores the data along with additional information in an immutable and trusted manner, such as for example by employing blockchain technology. The additional information stored in the blockchain can include third party data, the types of risk models and machine learning techniques employed by the system, as well as the data outputted from the enrichment or cognitive intelligence unit. Specifically, the environmental data, the enriched data, the machine learning models and techniques applied to the data, and the insights and conclusions generated by the enrichment unit can be stored in a blockchain of a digital trust infrastructure unit, thus enabling the system to cryptographically verify and store the logic and structure applied to the data so as to curate the data. The stored and verifiable data can also be used for subsequent reporting and analysis.

The present invention is directed to a data collection and processing system comprising a plurality of data sources for generating environmental data and a data analysis module for receiving the environmental data from the plurality of data sources. The data analysis module includes an enrichment unit for storing and enriching the environmental data from the plurality of data sources to form enriched environmental data. The enrichment unit includes a financial subsystem for analyzing and processing the environmental data and for generating financial data and non-financial data therefrom. The data analysis module also includes a digital trust infrastructure unit for storing the financial data and the non-financial data, where the enriched environmental data or the environmental data is stored in the data layer in a secure and verifiable format. The system also includes a post-processing unit for processing the environmental data and the financial data stored in the digital trust infrastructure so as to generate one or more reports from the environmental data and the financial data.

The data sources include a plurality of measuring devices coupled to one or more structures for measuring one or more selected parameters including one or more of power generation, power consumption, humidity, occupancy, and emissions of various fluids and gases, to form the environmental data. The data sources can also include pre-stored data including data from data libraries related to the parameters being measured by the measurement devices.

The enrichment layer comprises a data layer for storing the environmental data from the plurality of data sources and an applications interface unit having an application unit for storing one or more software applications for processing the environmental data in the data layer, and a third party data unit for storing third party data that is related to the environmental data stored in the data layer. The enrichment layer can also include a cognitive intelligence unit for applying one or more pre-defined intelligence techniques to the environmental data so as to process and enrich the environmental data to form the enriched environmental data. The pre-defined intelligence techniques can include one or more of a machine learning technique, an artificial intelligence technique, a natural language processing technique, neural networks, statistical techniques, or a risk modelling technique. Further, the third party data can include one or more of weather data, occupancy data, satellite data, optical data, physical enterprise data, maintenance related data, equipment related data, spatial related data associated with structures, enterprise data, and asset management related data.

The system of the present invention can also include a computing layer for storing the data from the plurality of data sources prior to storing the data in the data layer. The digital trust infrastructure unit employs a blockchain for storing any combination of the environmental data, the enriched environmental data, the financial data, and one or more of the pre-defined techniques. Further, the cognitive intelligence unit can further include a recommendation engine for applying a machine learning technique to the environmental data from the data layer to generate predictions based on the environmental data. The cognitive intelligence unit can further include a risk model unit for applying one or more risk modelling techniques to the environmental data from the data layer. The risk model unit and the recommendation engine consume the enriched environmental data that is stored in the digital trust infrastructure unit, and the digital trust infrastructure unit employs a blockchain for storing the enriched environmental data.

The post-processing unit includes one or more software applications for processing and integrating the enriched environmental data stored in the blockchain to generate one or more reports from the enriched environmental data. The post-processing unit can further include a data visualization software application for analyzing the enriched environmental data and then displaying the data in a graph-type visualization format.

The system of the present invention can also include a token creation unit for creating tokens from the environmental data collected from a plurality of measuring devices, or the enriched environmental data, or data provided by a third party to form one or more financial derivatives. The financial derivatives can include a carbon credit, a renewable energy credit, an emissions reduction credit, or a carbon offset.

The post-processing unit can also include any combination of an emissions accounting unit for processing the enriched environmental data to provide one or more reports related to tracking and determining emissions of an enterprise; an emissions management unit for processing the enriched environmental data to manage the emissions of the enterprise; an emissions reporting unit for processing the enriched environmental data to generate one or more reports directed to an emissions profile of the enterprise; an emissions trading unit for processing the enriched environmental data to provide information relating to trading of one or more emission related credits between enterprises; a risk management unit for processing the enriched environmental data to determine and manage a financial risk or a non-financial risk to the enterprise based on the environmental data; and a governance reporting unit for processing the enriched environmental data and generating based thereon a report directed to a governance profile of the enterprise.

The emissions accounting unit determines the emissions of the enterprise or building or infrastructure and determines and tracks energy consumption of the enterprise based on the enriched environmental data. The emissions management unit determines overall energy consumption of the enterprise and based on the enriched environmental data procures energy and one or more other utilities including water for the enterprise. The emissions reporting unit generates one or more reports based on climate data and the enriched environmental data to certify the accuracy of the emissions of the enterprise based on the emissions determined by the emissions accounting unit, the overall energy consumption determined by the emissions management unit, and one or more tokens created by a token creation unit from the environmental data collected from a plurality of measuring devices. The emissions trading unit is configured to determine a carbon allowance associated with the enterprise and to track and certify any tokenized carbon credits or renewable energy certificates or emissions reduction credits associated with the emission offsets of the enterprise.

The present invention is also directed to a computer-implemented method for collecting and processing data, comprising generating environmental data from a plurality of data sources, and providing a data analysis module for receiving the environmental data from the plurality of data sources. The data analysis module includes an enrichment unit for storing and enriching the environmental data from the plurality of data sources, wherein the enrichment unit includes a financial subsystem for analyzing and processing the environmental data and for generating financial data therefrom, and a digital trust infrastructure unit for storing the financial data, the enriched environmental data or the environmental data stored in the data layer in a secure and verifiable format. The method also includes processing the environmental data and the financial data stored in the digital trust infrastructure with a post-processing unit so as to generate one or more reports from the environmental data and the financial data.

The enrichment layer is configured for storing the environmental data from the plurality of data sources in a data layer, storing one or more software applications for processing the environmental data in the data layer in an application unit, storing third party data that is related to the environmental data stored in the data layer in a third party data unit, and applying one or more pre-defined techniques to the environmental data so as to process the environmental data in a cognitive intelligence unit. The pre-defined techniques include a machine learning technique, an artificial intelligence technique, or a risk modelling technique.

The method of the present invention can also include storing the data from the plurality of data sources prior to storing the data in the data layer in a computing layer. The digital trust infrastructure unit employs a blockchain technique for storing the data. Further, the third party data includes maintenance related data, equipment related data, spatial related data associated with one or more structures, enterprise data, asset management related data, and weather related data.

The method of the present invention an also include a token creation unit for creating tokens from the environmental data collected from a plurality of measuring devices, from the enriched environmental data, or from the third party data. The digital trust infrastructure unit is configured for storing the financial data, the environmental data, the enriched environmental data, and one or more of the pre-defined techniques.

The post-processing unit can further include any combination of an emissions accounting unit for processing the enriched environmental data to provide one or more reports related to tracking and determining emissions of an enterprise; an emissions management unit for processing the enriched environmental data to manage the emissions of the enterprise; an emissions reporting unit for processing the enriched environmental data to generate one or more reports directed to an emissions profile of the enterprise; an emissions trading unit for processing the enriched environmental data to provide information or reports related to trading of one or more emission related credits between enterprises; a risk management unit for processing the enriched environmental data to determine and manage a financial risk to the enterprise based on the environmental data; and a governance reporting unit for processing the enriched environmental data and generating based thereon a report directed to a governance profile of the enterprise.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic representation of the data collection and processing system according to the teachings of the present invention.

FIG. 2 is a more detailed schematic representation of the data collection and processing system of FIG. 1 according to the teachings of the present invention.

FIG. 3 is an example data collection and processing system for collecting, processing and analyzing environmental data according to the teachings of the present invention.

FIG. 4 is a schematic block diagram showing the functional units associated with one embodiment of the post-processing unit of the data collection and processing system of the present invention.

FIG. 5 is a schematic block diagram illustrating exemplary hardware that can be employed by portions of the system and by an electronic device employed thereby according to the teachings of the present invention.

### DETAILED DESCRIPTION

The present invention is directed to a data collection and processing system that can be used as an overall financial system (e.g., a tax, accounting, auditing, consulting or advisory system) and associated method therefor for generating and collecting usable, cryptographically verifiable environmental data, enriching the data with data from strategic third party data sources, and then applying if needed advanced risk modelling, machine learning and artificial intelligence techniques, so as to generate strategic reports, such as financial reports and other business-related reports.

The present inventors have realized that there is a need in the art for selected financial type solutions because of the increase in client demand for advice that takes into consideration environmental data. That is, the inventors have realized that enterprises, such as businesses and companies, should consider or understand the climate risk on asset valuations; better assess, understand and respond in appropriate ways to any risks that climate change presents to business operations; employ better systems for accurately assessing, tracking, managing and considering carbon emissions, carbon reductions, and carbon offsets; and secure the data in a trusted, immutable and easily verifiable manner such that the stored and secured data can be easily audited.

As used herein, the term “environmental data” or “environmental information” is intended to include any type of data associated with the surroundings, conditions or activities of any natural structure, such as the Earth and components thereof, any artificial or man-made structure or enterprise, such as a building or a device, or an organization, entity or individual. The data associated therewith can also include any associated identifiable element in the physical, cultural, demographic, economic, political, regulatory, climatic, or technological environment that affects the survival, operations, and/or growth of any of the foregoing. The data can also concern the physical, chemical (e.g., chemicals, fluids, gases and the like), and/or biological factors that can act upon the natural and man-made structures. The physical environment can include the atmosphere, climate, hydrosphere, ocean, and land. The climate related data can include solar radiation data, temperature data, humidity data, precipitation data (e.g., type, frequency and amount), atmospheric pressure data, and wind data (e.g., speed and direction). The land related data can include data associated with mountains, plateaus, and valleys, either above sea level or below sea level. The hydrosphere data can include any data related to any water in any form (e.g., liquid, frozen, or vapor) anywhere on Earth. The data can also include power related data that includes for example the consumption of power by different types of building equipment to maintain occupant comfort, air quality, lighting, and the like, as well as data power data related to the generation of power from any selected power source and/or feedstock, including for example oil-based power generation, gas-based power generation, coal-based power generation, solar energy, wind energy, or tidal or water generated energy.

As used herein the term “financial data” can include any data that is associated with or contains financial or financial related information. The financial information can include information that is presented free form or in tabular formats and is related to data associated with financial, monetary, or pecuniary interests. Further, as used herein, the term “non-financial data” is intended to include all data, including if appropriate environmental data, that is not financial data as defined herein.

As used herein, the term “enterprise” is intended to include a structure or collection of structures (e.g., buildings), facility, business, company, operation, organization, country, or entity of any size. Further, the term is intended to include an individual or group of individuals, or a device of any type.

As used herein, the term “financial unit, “financial subsystem,” “financial system” or “financial infrastructure” is intended to include any unit implemented in hardware, software or a combination thereof that applies financial rules and models to data of any type, including financial data and environmental data, so as generate one or more financial reports. The financial rules and modeling can include applying known and/or custom business concepts, accounting concepts, tax concepts, audit concepts, consulting concepts or advisory concepts.

As used herein, the term “financial reports” is intended to include any statement or report that exists in any suitable format (e.g., printed or in digital file format) that sets forth or includes financial data, including, for example, tax returns, income statements, cash flow statements, balance sheets, 10-K statements, 10-Q statements, audit reports, annual reports, loan applications, credit history reports, invoices, and the like.

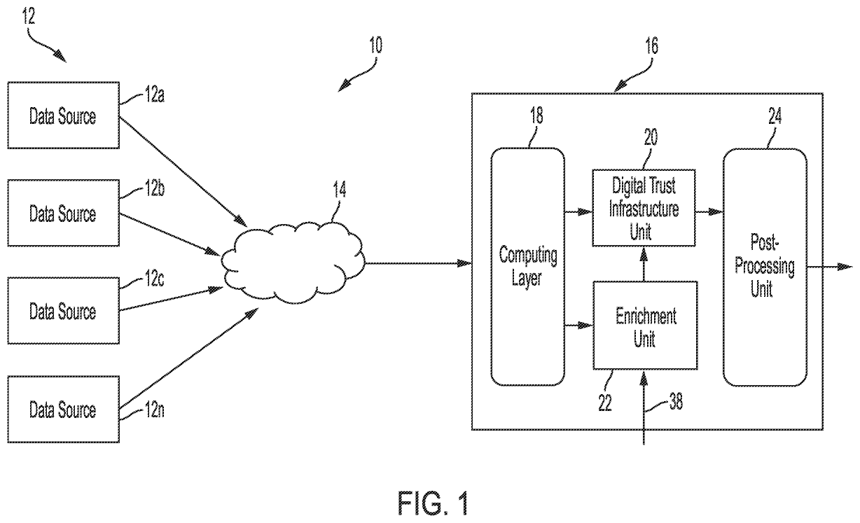

FIG. 1 is directed to a system for collecting or aggregating data, such as for example environmental data, from a variety of different sources, and then enriching and processing the data for subsequent use in a variety of different ways. As shown, the data collection and processing system 10 can include a plurality of data sources 12, and specifically data sources 12a-12n that are sources of data to be processed by the data collection and processing system 10 of the present invention. According to one example, the data sources can include devices, such as detectors, sensors, and the like that are measuring selected data, such as environmental data. The data acquired by the data sources 12a-12n can be conveyed through any suitable data connection via the network 14 to a data analysis subsystem or module 16. The data analysis module 16 stores and analyzes the data received from the data sources 12. The data analysis module 16 can operate as a financial system or infrastructure for storing the data from various data sources, enriching and processing the data to generate insights and the like, securing the data in a trusted and verifiable manner, and then provide the data to suitable report generating software applications for generating one or more reports, insights, risk modelling, and the like.

The illustrated data analysis module 16 can include an optional computing layer 18 for providing optional computing and storage capabilities closer to the edge of the network 14. By providing the computing and storage resources closer to the data sources 12 on the network, the computing layer 18 can hence move computation away from data centers and other computing elements towards the edge of the network, thus exploiting for example suitable software applications, smart objects, or network gateways to perform processing tasks and provide services on behalf of the remaining system computing resources. By moving services to the edge, it is possible to provide content caching, service delivery, storage and IoT management resulting in better response times and transfer rates. The computing layer 18 thus reduces the volume of data that must be moved, the consequent data traffic over the network, and the overall distance that data must travel. The computing layer 18 can also include if desired relevant applications that can be selected based on the type of data that is transmitted from the data sources 12. Further, the computing layer can employ known virtualization technology for providing enhanced computing services closer to the data sources 12. Alternatively, the computing layer 18 can simply provide processing and storage capabilities, and hence can form part of the data analysis module 16 or can be a separate component. For purposes of simplicity and for ease of explanation, the computing layer 18 is shown as forming a part of the data analysis module 16, although one of ordinary skill in the art will readily recognize that the computing layer 18 can be a separate unit.

The data analysis module 16 can also include a digital trust infrastructure unit 20 for generating trusted and verifiable data via known techniques, such as for example by using blockchain technology. The digital trust infrastructure unit 20 can secure in a trusted and verifiable way data that is received from one or more components of the data collection and processing system 10, such as for example from the data sources 12, from third party data source providers 38, and from pre-stored data. The data once secured is resistant to change and is easily verifiable. The data secured in the digital trust infrastructure unit 20 can be open for inspection or access to the data can be restricted in known ways. Also included in the data analysis module 16 is an enrichment unit 22 for enriching the data received from the data sources 12 with for example data received from one or more third party sources 38 and/or with the pre-stored data. The enrichment unit 12 can also apply various well known techniques to the data prior to being stored in the digital trust infrastructure unit 20, such as by using machine learning, artificial intelligence and risk modeling techniques. The enrichment unit 22 serves to ingest and/or enrich the data prior to being stored in the digital trust infrastructure unit 20. As used herein, the term “enrich” or “enriched” is intended to include the ability to ingest and integrate data, and then apply logic and structure to the data so as to curate the data. The term enrich can also include the ability to correlate factors to the data so as to generate or create meaningful insights and conclusions based on the data, including environmental and financial data. The environmental data, the enriched data, the machine learning models and techniques applied to the data, and the insights and conclusions generated by the enrichment unit 22, can also be stored in the blockchain 20A of the digital trust infrastructure unit 20, thus enabling the system to cryptographically verify and store the logic and structure applied to the data so as to curate the data. The stored and verifiable data can also be used for subsequent reporting and analysis.

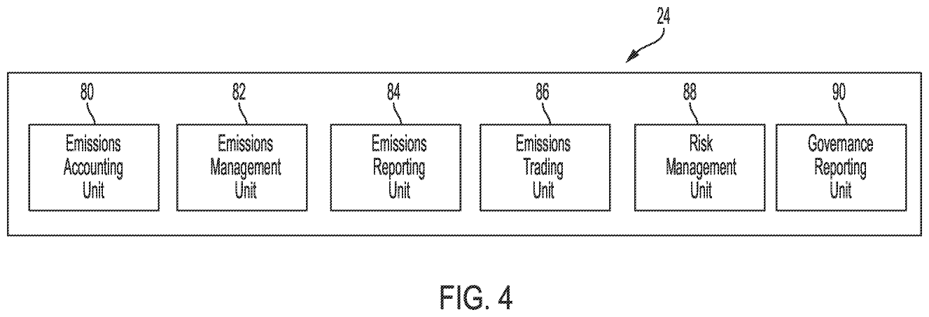

The illustrated data analysis module 16 can also include a post-processing unit 24 for processing the data that is stored within the digital trust infrastructure unit 20. The post-processing unit 24 can include any selected software application, such as suitable report generating applications, for generating reports of any type and kind, including financial reports. The post-processing unit 24 can also include, as shown in FIG. 4, one or more optional units, such as for example an emissions accounting unit 80, an emissions management unit 82, an emissions reporting unit 84, an emissions trading unit 86, and a risk management unit 88.

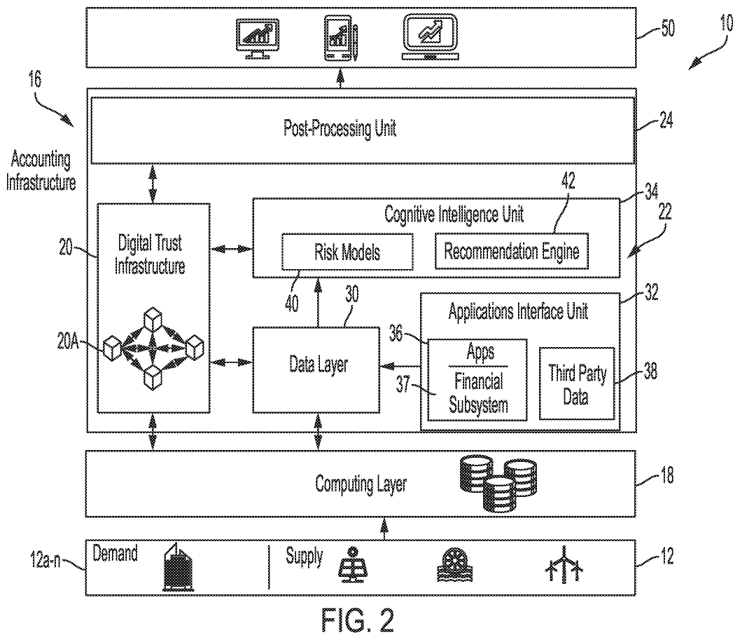

FIG. 2 is a schematic representation of the data collection and processing system 10 showing additional details of the data sources 12a-12n and various units of the data analysis module 16. The data collection and processing system 10 of the present invention includes the data sources 12 that can include any selected type of data, including for example financial data, environmental data, and the like, as well as combinations of different types of data. According to one illustrative example, the data sources 12a-12n can include data that is generated by a plurality of sources or different measuring devices, including for example sensors, detectors, measurement devices and the like. The measuring devices can be coupled to any suitable structure or facility to measure any selected parameter, including for example power generation, power consumption, humidity, occupancy, emissions of various fluids (e.g., liquids and gases) and the like. Further, the data sources 12 can include any selected pre-stored data such as from data libraries relevant to the parameters being detected and/or measured. The data generated or collected by the data sources can include structured as well as unstructured data. The data from the data sources 12 is then conveyed to the computing layer 18. The computing layer 18 can form part of the data analysis module 16 or can be a separate component therefrom. The computing layer can include selected computing hardware, such as processors, memory and storage. The data from the data sources 12 can be stored at the computing layer 18. The computing layer 18 can include relevant software applications and associated protocols for interfacing with the devices, ensuring device connectivity, the ability to process and log the data, store the data, and the like.

The data stored in the computing layer 18 can be conveyed directly to either or both of the digital trust infrastructure unit 20 and the enrichment unit 22. The enrichment unit 22 can include a data layer 30, an application interface unit 32, and a cognitive intelligence unit 34. The data layer 30 is configured to receive the data from the computing layer 18 and then process and store the data therein. The data stored in the data layer 30 can be enriched in various ways. For example, the data can be enriched by one or more of the application interface unit 32 and the cognitive intelligence unit 34. The application interface unit 32 can include and store specific software applications in an application unit 36 that are directed or related to the type of data provided by the data sources. For example, if the data includes environmental data, then environmental data specific applications can be employed, such as for purposes of example the Nantum OS application from Prescriptive Data, USA. The Nantum OS software application unlocks correlated trends and analyzes data from devices such as sensors in disparate building systems (including building management systems (BMS), utility and power quality meters, and access control) and combines this with data from third-party sources 38 to prescribe operational adjustments in real-time that improve building performance and tenant comfort. The application interface unit 32 can also store third party data 38, such as for example, any type of data that is related to the type of data stored in the data layer 30. If the data stored in the data layer is environmental data, then the third party data can include for example weather data, occupancy data, satellite data, optical data, physical enterprise data such as data associated with one or more structures, IoT sensors, maintenance related data, equipment related data, spatial related data associated with structures, enterprise data, asset management related data, and the like.

The application unit can also include a financial subsystem 37 for storing appropriate financial software applications for applying financial rule sets and logic to the data in the data layer 30 as well as to data that has been enriched by applications, third party data, and/or by the cognitive intelligence unit 34. According to one example, the financial subsystem 37 can apply accounting concepts or business or advisory concepts to the data.

The cognitive intelligence unit 34 can apply risk modelling techniques, artificial intelligence techniques and/or machine learning models or techniques to the data prior to being stored in the digital trust infrastructure unit 20. The various techniques enable real-time adjustments of the data received from the data layer based on various factors, including data type and how the data is used by the enterprise. For example, the environmental data can be employed to make adjustments to one or more parameters of an enterprise, such as by adjusting the temperature, fan speed, lighting, and the like. The system can alternatively be used to assess, monitor or predict the carbon foot-print (usage and emissions) of an enterprise on any time scale. For example, the recommendation engine 42 can employ one or more machine learning techniques that can include a variety of algorithms (e.g., supervised learning, unsupervised learning, reinforcement learning, knowledge-based learning, natural-language-based learning such as natural language generation and natural language processing, deep learning, and the like) and can access execution engines comprising software applications that enable implementation of the underlying algorithm. As is known, the machine learning techniques are trained using training data. This training data is used to modify and fine-tune the weights associated with the machine learning models, as well as record ground truth for where correct answers can be found within the data. As such, the better the training data, the more accurate and effective the machine learning model can be. The recommendation library or engine 42 processes the data in the data layer by applying one or more machine learning or artificial intelligence techniques so as to generate or extract recommendations, insights, predictions and the like from the data. The cognitive intelligence unit 34 can also employ a risk model unit 40 that includes suitable software for applying one or more risk modelling techniques to the data that model or address strategic, operational, compliance, geopolitical, and other types of risk. The wider availability of data and sophisticated analysis capabilities of the risk models makes modeling more practical. As is known, a risk model is a mathematical representation of a system that commonly includes probability distributions. The models use relevant historical data as well as relevant third party data to understand the probability of a risk event occurring and its potential severity from the input data. Thus, the risk models can be employed to assess many different types of risks. In the current system 10, the risk model unit 40 can process the data in the data layer 30 that is received from the data sources, such as device level data, so as to project, predict or calculate selected risks to an enterprise.

The data from the computing layer 18 or the enriched data from the enrichment unit 22 can be stored in the digital trust infrastructure unit 20. For example, the data (e.g., original data) from the computing layer 18 can be stored directly in the digital trust infrastructure unit 20. Alternatively, the original data can be conveyed to the data layer 30, and the original data can be enriched to form enriched data by one or more of the data received from the third party sources 38, by the software applications 36, by the software in the financial subsystem 37, by the risk modelling software stored in the risk model unit 40, or by the machine learning or artificial intelligence techniques implemented by the recommendation engine 42. As such, the data collection and processing system 10 can be configured to store in addition to the original data the enriched data as well as the techniques or third party data that was employed to enrich the original data in the blockchain 20A. The digital trust infrastructure unit 20 preferably stores the original data and the enriched data in a trusted and verifiable format. According to one practice, the data can be stored using blockchain technology. In a blockchain 20A, as is known, the data can be stored in a series of batches or blocks that include among other things a time stamp, a hash value of the data stored in the block, and a copy of the hash value from the previous block. The blockchain 20A is shared with a plurality of nodes in a blockchain network in a decentralized manner with no intermediaries. Since many copies of the blockchain exist across the blockchain network, the veracity of the data in the blocks can be easily tracked and verified. Each instance of new data from the data sources 12 or data and models and techniques employed by the enrichment unit 22 can be stored in a block on the blockchain. The blockchain 20A thus functions as a decentralized or distributed ledger having data associated with each block that can be subsequently reviewed and/or processed. The data in the blockchain can be tracked, traced, and presented chronologically in a cryptographically-verified ledger format of the blockchain to each participant of the blockchain. As such, the blockchain can provide an audit trail corresponding to all of the data in the blocks, and thus can determine who interacted with the data and when. According to one embodiment, each node of the blockchain network can include one or more computer servers which provides processing capability and memory storage. Any changes made by any of the nodes to a corresponding block in the blockchain are automatically reflected in every other ledger in the blockchain. As such, with the distributed ledger format in the blockchain, provenance can be provided with the dissemination of identical copies of the ledger, which has cryptographic proof of its validity, to each of the nodes in the network. Consequently, all of the various types of data (e.g., original data, enriched data, the software and models and techniques employed to enrich the data, and the insights and recommendations generated therefrom) can be stored in the blockchain 20A, and the blockchain 20A can be used to verify, prove and create an immutable record of the data, various rule based models and techniques, risk models, and machine learning and artificial intelligence models and techniques stored therein as well as to track users accessing the data and any associated insights generated by the enrichment unit.

The data stored in the blockchain 20A of the digital trust infrastructure unit 20 can be viewed, retrieved and processed using the post-processing unit 24. For example, the post-processing unit 24 can include one or more software applications that processes and integrates the data stored in the digital trust infrastructure unit 20 so as to generate one or more reports that are configured to provide information to a system user that is related to the data. For example, the post-processing unit 24 can employ data visualization software that analyzes the data and then displays the data in selected visualization formats, such as graph-type visualization formats. The post-processing unit 24 can also be configured to create standardized and configurable reports for clients specific to their jurisdictional compliance requirements, as well as provide business insights and associated analytics from the data. The reports can also be industry specific, domain specific, or can generate or create reports that relate to risk monitoring and controls. The reports can include financial reports and the like. According to one practice, the reports can include, when processing environmental data, an emission history report, water usage report and other enterprise (e.g., building) specific reports, as well as provide a summary dashboard showing selected metrics or parameters, including building efficiency and the like. An example of suitable data visualization software includes the various software applications products from Tableau Software, USA. An example of a suitable data integration and business analytics software includes the various software applications from Qlik. The reports generated by the post-processing unit 24 can be displayed in a display region 50. The display region can include one or more displays or monitors for displaying the reports. The displays can be separate display devices or can form part of any suitable electronic device, such as for example a computer, tablet or smartphone.

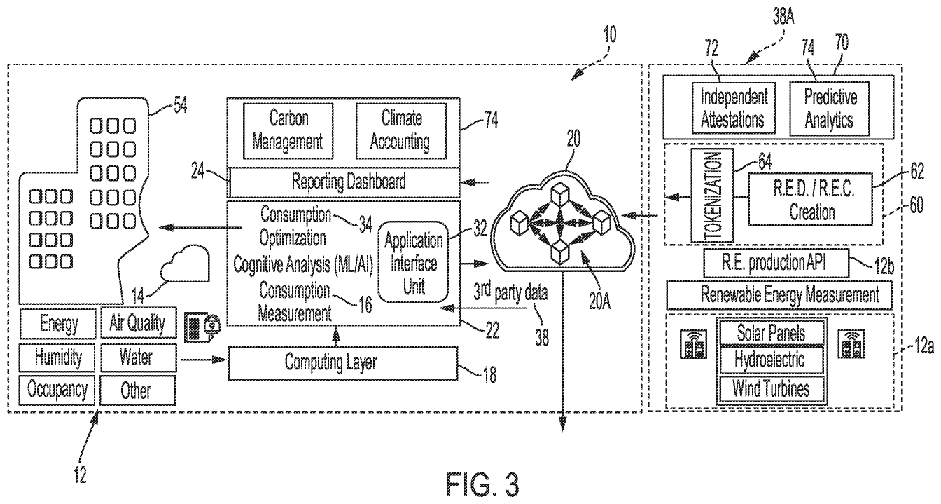

The data collection and processing system 10 of the present invention can be employed to create an environmental and financial infrastructure for allowing financial institutions to process environmental and/or financial data so as to provide financial, tax, accounting, consulting, and business related services (including risk modelling services) to clients. By way of example, and for purposes of simplicity, FIG. 3 shows an example of the data collection and processing system 10 configured for processing environmental data according to an exemplary technique. Those of ordinary skill in the art will readily recognize that the system 10 can be employed to gather, process and analyze many different types of data. The data can be provided by data sources 12 that provide environmental data associated with a structure, such as a building 54. In the illustrated embodiment, the data sources 12 can provide original or raw environmental data associated with various building associated parameters, such as for example, energy consumption, humidity, occupancy, air quality, water usage, and the like. The original environmental data can be communicated via the network 14 to the computing layer 18 and then to the data analysis module 16. Specifically, the original environmental data can be collected in the computing layer 18 and can be indicative of asset grade environmental data. An example of a software application that can be employed to ingest or collect the environmental data in the computing layer 18 is any of the suitable software application from Context Labs. The original environmental data stored in the computing layer 18 is then transferred or conveyed to the enrichment unit 22 of the data analysis module 16. The enrichment layer 22 can include for example the application interface unit 32 and the cognitive intelligence unit 34. In the application interface unit 32, suitable software, such as Nantum OS from Prescriptive Data, can store and analyze the environmental data received from the data sources 12 associated with the building 54. The enrichment layer 22 can recommend adjustments to be made to the building operational systems so as to improve overall building efficiency and tenant comfort. The application interface unit 32 can also include the financial subsystem 37, FIG. 2, for applying financial concepts and logic to the environmental data and for generating or extracting financial data therefrom. Further, environmental data from the third party sources 38 can also be provided to further enrich the original environmental data and optionally the financial data. The third party data 38 can include for example environmental data associated with the operations of the building 54 or similar or different types of buildings, specifications of equipment employed in the building 54, external environmental data such as geospatial, weather, temperature, humidity, wind, sun exposure and the like, spatial information regarding the building layout, power grid information, and maintenance information regarding one or more aspects of the physical plant. This list of third party data is merely exemplary and is not intended to be exhaustive. The third party data 38 is intended to improve the quality and integrity of the environmental data. The cognitive intelligence unit 34 can include techniques or models for synthesizing, improving or optimizing the original environmental data, including data associated with overall consumption and measuring of the overall consumption, and then subsequently analyzing the data using risk modelling, machine learning or artificial intelligence techniques. The cognitive intelligence unit 34 can derive insights relative to the environmental data for decision making, performance, optimization and risk management. The processed and analyzed (e.g., enriched) data in the enrichment unit 22 can then be conveyed back to the building 54 to adjust or control on or more building environmental or operational parameters and/or can be conveyed to the digital trust infrastructure unit 20. When conveyed back to the building 54, the various systems in the building can be modified so as to operate the physical facility in a more cost and environmentally friendly and efficient manner.

The digital trust infrastructure unit 20 can utilize any known technique for storing and securing the original environmental data, the enriched environmental data, as well as the specific risk models and machine learning and artificial intelligence techniques that were employed by the enrichment unit 22 to enrich the environmental data. According to one practice, the environmental data can be secured or stored using blockchain technology. The digital trust infrastructure unit 20 can thus employ a blockchain 20A to store the foregoing types of data, including enriched data, in a decentralized, trusted and cryptographically verifiable manner. The data can be stored therein according to known techniques. The data can include the original device level environmental data as well as the enriched data that is secured and verified, and hence is trusted. The blockchain 20A can also store data directly from additional third party sources 38A. The third party sources 38A can include supply data, such as for example power supply data including environmental data 12a associated with selected types of renewable energy, such as solar, wind, or hydroelectric, that are being generated or produced at selected power installations. The third party data 38A can also include environmental data 12b generated by third party applications associated with or directed to renewable energy production, such as data collated and processed by software applications by SwytchX.

The illustrated third party sources 38A can also include an optional token creation unit 60 for receiving or collecting data associated with renewable energy production and emissions from selected installations and creating tokens related to this data. The tokens can represent any physical or digital pre-defined or selected amount or quantum of value. The tokens can be purchased, sold, exchanged, traded or redeemed per the system requirements. The system can also track the tokens if desired. The renewable energy production and renewable energy emissions can be converted into renewable energy credits and renewable energy debits by a conversion unit 62. The renewable energy credits and debits can be converted into tokens by a tokenization unit 64. The tokens created by the tokenization unit can be conveyed to the digital trust infrastructure unit 20 for storing in the blockchain 20A. The third party data sources 38A can also include an optional financial verification unit 70 for verifying data, tokens or related information associated with the third party sources 38A. The verification unit 70 can include an optional attestation unit 72 for providing attestation data associated with selected environmental data or tokens and which can be provided by any selected financial institution or attestation body, such as for example an accountant, accounting firm, attorney, law firm, business, and the like. The attestation data is a documented verification of the validity of the underlying data. The verification unit 70 can also include an optional predictive analytics unit 74 for analyzing selected data and for providing predictions based on the data. All of the information received from the third party source 38A can be transferred to the digital trust infrastructure unit 20 for storing therein.

The data stored in the blocks of the blockchain 20A can be retrieved and processed by the post-processing unit 24 to generate one or more reports, such as environmental or financial reports, or other types of reports, via one or more suitable report generation applications. The environmental data can be employed to identify and analyze the building units that are generating emissions and how best to reduce the emissions and how the building is being powered. From this environmental data, the data analysis module 16 can determine the operational health of the building and associated systems, and perform a risk analysis on the physical building and associated external and internal climate. The reports can include among other things reports on green house gas emissions, green house gas optimization, carbon emission setting and optimization, risks and associated controls, transaction settlements, net-zero emissions compliance, and carbon pricing. The post-processing unit 24 can also optionally create if desired a reporting dashboard. The reports and the dashboard can be displayed in the display region 50, FIG. 2. The enrichment unit 22 can also include an optional financial analysis unit 74, similar to the financial subsystem 37, that can reside for example as part of the cognitive intelligence unit 34 or as a separate component or unit. The financial analysis unit 74 can analyze the data received from the digital trust infrastructure unit 20 to identify, process and analyze certain financial aspects of the environmental data. For example, the data can be processed using standard financial or accounting rules, logic and models and techniques. Also the financial analysis unit 74 can determine the carbon footprint associated with the environmental data. The financial analysis unit 74 can be used in place of the financial subsystem 37 or can be used in conjunction with the financial subsystem 37.

The post-processing unit 24 can also be configured to generate reports, which can include selected environmental data that is important to a selected client relative to one or more enterprises or buildings, and then display the reports to the system user. The reports can be constructed so as to allow the user to view and analyze the data, such as environmental data, so as to help make decisions or to take or recommend actions in response thereto and which are related to selected system capabilities or functionalities, including for example emissions accounting, emissions management, emissions reporting, emissions trading, and risk management. The data collection and processing system 10 of the present invention can employ selected software modules or units in the post-processing unit 24 directed to one or more of the foregoing capabilities. The selected software modules can be configured to process data from one or more selected types of data sources 12, thus allowing the client to access granular environmental data, such as for example emissions related data, so as to derive insights across the users operations in near real time.

FIG. 4 is a schematic block diagram showing the post-processing unit 24 configured to optionally include or employ one or more selected units for generating one or more reports directed to a selected system capability or functionality of the enterprise. For example, regarding the emission accounting capability, the post-processing unit 24 can be configured to include an optional emissions accounting unit 80 that can include one or more software applications and associated hardware for processing the enriched environmental data to aggregate data related to the energy consumed or used by the enterprise, such as a structure or collection of structures (e.g., buildings), equipment, facility, business, company, operation, organization, country or entity, to compute various emissions-related metrics using standard emissions factors available from third-party sources, for example, the emissions factors provided by the International Energy Agency (IEA); to track emissions relative to established emissions goals for a specific building, equipment, enterprise, or country; and to determine the overall emissions related liabilities of the enterprise. Specifically, the emissions accounting unit 80 can determine or calculate the emissions of an enterprise or building, determine and track energy consumption of the enterprise, and/or determine or track the overall emissions goals for the enterprise based on the environmental data and/or third party data following various known climate-related accounting standards and frameworks. The climate related standards can include for example standards and frameworks established by greenhouse gas protocols, sustainability accounting standards boards (SASB), task forces on climate-related financial disclosures (TCFD), global logistics emissions council (GLEC), and global reporting institute (GRI). The emissions accounting unit 80 can also be configured to track emissions generated from their operations with the required level of granularity or specificity for deciding specific to reducing emissions through various known carbon management strategies. For example, the emissions accounting unit 80 can use the environmental data to determine the biggest emission generators in the building and then take selected emissions remediation actions (e.g., climate actions), such as for example upgrade the emission sources, initiate repair or maintenance of selected building components, and to forecast future investment needs. The climate actions can also include for example initiatives related to carbon reduction (e.g., energy efficiency), carbon removal, carbon offsetting, carbon capture and storage, and the like.

The post-processing unit 24 can also include an optional emissions management unit 82 that can include one or more software applications and associated hardware for processing the enriched environmental data to manage the emissions of the enterprise. Specifically, the emissions management unit 82 can determine or calculate the emissions reduction achieved by the enterprise when utilizing different energy optimization measures, projects or programs via suitable software applications, the replacement of equipment, retrofitting equipment with advanced sensor and control capabilities, or automating command and control of the building control systems and associated IoT devices. The emissions management unit 82 can also determine the overall energy consumption of the enterprise and allow the integration of this enriched environmental data with third party data sources to facilitate the procurement of energy for the enterprise. For example, the enterprise can leverage the enriched environmental data generated by the enrichment unit 22 by applying artificial intelligence or machine learning or other advanced analytics techniques to determine the right mixture of energy to use, in the right amounts, at optimal prices from energy suppliers. The emissions management unit 82 can also include suitable software for tracking carbon prices as set forth by regulatory bodies specific to a jurisdiction or by the enterprise, and facilitate the determination of carbon-related liabilities applicable to the products or services or both of the enterprise. In addition, the emissions management unit 82 can use the enriched environmental data for collecting the carbon-related liabilities from enterprises or business units or other sources, acquiring the environmental funds provided by various sources identified by the enterprise and others, and tracking the allocation of the funds for investing in various climate actions of the enterprise. This can also include determining the insights related to managing the emissions fund with necessary audit, tax and risk management models.

The post-processing unit 24 can further include an optional emissions reporting unit 84 that can include one or more software applications for processing the enriched environmental data to generate a report directed to the emissions profile of the enterprise in compliance with jurisdiction specific regulations. Specifically, the emissions reporting unit 84 can generate one or more reports that includes climate data and generate one or more reports directed to certifying the accuracy of the inventory of greenhouse gas emitters, certifying the source of the environmental data with necessary third party verification data, and the methodology and/or technique used to calculate emissions. The emissions reporting unit 84 can also employ suitable computation engines to automatically generate relevant disclosure statements to be included in the report. The emissions reporting unit 84 can further be configured to automatically generate standardized or custom climate disclosure reports in compliance with jurisdictional laws, such as local, state, and federal laws, and specific regulatory guidelines. The reporting unit can also be configured to certify the reports use by shareholders of the enterprise as part of associated financial disclosures and annual reports, thus allowing the shareholders the ability to assess and track the climate progress of the enterprise. The emissions reporting unit 84 can employ pre-defined techniques to track and analyze the impact of the different climate actions undertaken by the enterprise to reduce their overall emissions and leverage the insights generated by the cognitive intelligence unit 34 for subsequent emissions planning.

The post-processing unit 24 can still further include an optional emissions trading unit 86 that can include one or more software applications for processing the enriched environmental data to provide information or reports related to the trading of emission related credits between enterprises. More specifically, the emissions trading unit 86 can determine or calculate a carbon allowance (e.g., cap or target) associated with the enterprise and to track or record any carbon credits purchased by the enterprise from third party sellers; to generate one or more digital tokens representative of the excess carbon available as credits; to manage the trading of carbon credits or tokens in a related marketplace; and/or to track the aggregated (“earned”) carbon credits available with the enterprise or used by the enterprise in compliance with regulatory and jurisdictional guidelines at the required granularity specific to the enterprise.

The post-processing unit 24 can also include an optional risk management unit 88 that can include one or more software applications and associated hardware for processing the enriched environmental data to model or determine and hence manage any financial risk to the enterprise based on the environmental data. More specifically, the risk management unit 88 can determine the financial risk via a financial risk value or score associated with the enterprise based on the enriched environmental data or environmental data, evaluate the impact of various climate scenarios on the sustainable financial performance of the enterprise, evaluate supply chain and operations of the enterprise, and determine any existing and potential vulnerabilities in the systems available within the enterprise, based on the environmental data, and/or to determine whether the enterprise complies with selected regulations and to mitigate any deficiencies related thereto. The risk management unit 88 can also generate insights that can help the enterprise value any associated assets, such as buildings, facilities, infrastructures, and the like, and determine the underlying risks when underwriting financial instruments, such as getting loans at the right interest rate, deciding on investment strategy, reconfiguring the fund allocation actions, managing the brand equity or defining or employing risk mitigation strategies to lower the impact of climate events or scenarios on the financial performance of the enterprise.

The risk management unit 88 can also generate insights from enriched environmental data collected from the assets, such as buildings, facilities, infrastructures, renewable energy generation solutions or systems including solar, wind, fuel cells, biofuels, and the likes, and energy storage systems including battery storage, gravity storage and the likes, to determine the financial and emissions impact of the investments made in such assets to achieve the carbon emissions reduction targets established voluntarily by the enterprise or mandated by regulations or an industry consortium or the likes. The risk management unit 88 can also generate insights from enriched environmental data to identify the key factors impacting the performance of an investment in the assets described above and benchmark or compare the emissions reduction-related commitments at different stages, such as project design, project qualification for investing, project execution, post-project execution, steady-state operations, selling, buying, leasing, and the likes, of financing the projects.

The post-processing unit 24 can further include an optional governance reporting unit 90 that can include one or more software applications for processing the enriched environmental data to generate a report directed to the social and governance profile of the enterprise in compliance with jurisdiction specific regulations. As used herein, the term “governance profile” is intended to mean any information associated with or directed or related to the social, corporate, employee, investment, social, or environmental aspects or governance of the enterprise. Specifically, the governance reporting unit 90 can generate one or more reports that includes environmental data, employee profile, investments made by the enterprise in community development, and the like, and the reporting unit 90 generate one or more reports directed to certifying the accuracy of the social and governance claims of the enterprise, certifying the source of the environmental data with necessary third party verification or notary or certification, and the methodology and/or technique used to assess performance of the enterprise against metrics established by regulators, standards bodies or enterprise policies. The governance reporting unit 90 can also employ suitable computation engines to automatically generate relevant disclosure statements to be included in the report. The governance reporting unit 90 can further be configured to automatically generate standardized or custom social and organizational governance-related disclosure reports in compliance with jurisdictional laws, such as local, state, and federal laws, and specific regulatory guidelines. The reporting unit 90 can also be configured to certify the reports use by shareholders of the enterprise as part of associated financial disclosures and annual reports, thus allowing the shareholders the ability to assess and track the progress of the enterprise towards established social and governance targets. The governance reporting unit 90 can employ pre-defined techniques to track and analyze the impact of the different climate actions undertaken by the enterprise to reduce their overall impact and performance leveraging the insights generated by the cognitive intelligence unit 34 for subsequent social and governance actions planning.

The data collection and processing system 10 of the present invention can measure, collect and calculate the different greenhouse gas (GHG) emissions from the operation related energy consumption of the enterprise, such as a building, for climate accounting purposes. The data collection and processing system 10 can also be configured to manage the emissions of the building as well as the related auditing functions, including monitoring, audit and control of the environmental parameters of the building. The system 10 can also be configured to optimize the environmental performance of the building and reduce the operational costs of the building, while concomitantly reporting the climate impact of the building in an accurate and transparent manner.

The data collection and processing system 10 of the present invention can also be employed by many different types of enterprises across many different types of business sectors that have a need or desire to employ environmental data, as well as other types of data, to reduce the overall carbon footprint of the business operations, lower operational costs, and mitigate climate risks that impact the financial performance of the business. Further, the system 10 of the present invention enables businesses to integrate environmental data to assess the quality of assets, such as property assets, measure the overall climate exposure of the asset, and advise businesses on the financial risks associated with the asset.

The data collection and processing system 10 of the present invention integrates different technologies in a cloud based manner to collect environmental data from various data sources 12 and thus form the backbone of an environmental accounting infrastructure. The system 10 can process, enrich, audit and authenticate the environmental data in a highly automated manner. The cognitive intelligence unit 34 of the data analysis module 16 can derive granular insights and help enterprises make predictions for how best to optimize the building systems and operations, so as to help mitigate the overall environmental impact of the building. The reporting functions of the post-processing unit 24 and the financial verification unit 70 can allow the attestation body (e.g., accounting firm) to attest and certify environmental related disclosures for financial and non-financial reporting and compliance within the context of standard accounting frameworks.

Further, the environmental financial system implemented by the data collection and processing system 10 allows enterprises to measure, manage, and reduce carbon emissions and help trace the energy supply and demand pipeline. The environmental data accumulated by the system 10 can be integrated with a high degree of confidence and trust into the financial analysis. The system can also help the attestation bodies track and account for carbon emissions and carbon removal (e.g., credits and debits) transparently and accurately. The attestation bodies can harness the accounting infrastructure of the system 10 to help clients understand the impact of climate risks on asset valuations and business operations.

It is to be understood that although the invention has been described above in terms of particular embodiments, the foregoing embodiments are provided as illustrative only, and do not limit or define the scope of the invention. Various other embodiments, including but not limited to those described herein are also within the scope of the claims. For example, elements, units, tools and components described herein may be further divided into additional components or joined together to form fewer components for performing the same functions. Further, the above described windows or screens can be generated by any selected portion or unit of the system 10, such as for example, by the post-processing unit 24. The system can also employ any selected portion or unit of the illustrated system 10 to generate the reports set forth herein, such as for example, by the post-processing unit 24.

Any of the functions disclosed herein may be implemented using means for performing those functions. Such means include, but are not limited to, any of the components disclosed herein, such as the electronic or computing device components described herein. That is, any unit or module of the illustrated system 10 can be implemented by using one or more of the electronic or computing devices disclosed herein.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

The term computing device or electronic device can refer to any device that includes a processor and a computer-readable memory capable of storing computer-readable instructions, and in which the processor is capable of executing the computer-readable instructions in the memory. The terms computer system and computing system refer herein to a system containing one or more computing or electronic devices.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may operate on digital electronic processes which can only be created, stored, modified, processed, and transmitted by computing devices and other electronic devices. Such embodiments, therefore, address problems which are inherently computer-related and solve such problems using computer technology in ways which cannot be solved manually or mentally by humans.

Any claims herein which affirmatively require a computer, a processor, a memory, or similar computer-related elements are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. For example, embodiments of the present invention solve the problem of how to process and then enrich environmental data, and store the enriched environmental data along with other data in a digital trust infrastructure unit 20, such as in a blockchain. There is no analog to this problem in the non-computer environment, nor is there an analog to the solutions disclosed herein in the non-computer environment.

Furthermore, embodiments of the present invention represent improvements to computer and communication technology itself. For example, the system 10 of the present can optionally employ a specially programmed or special purpose computer in an improved computer system, which may, for example, be implemented within a single computing device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program or computer readable product tangibly embodied in a machine-readable storage device for execution by a computer processor. Method steps of the invention may be performed by one or more computer processors executing one or more programs tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

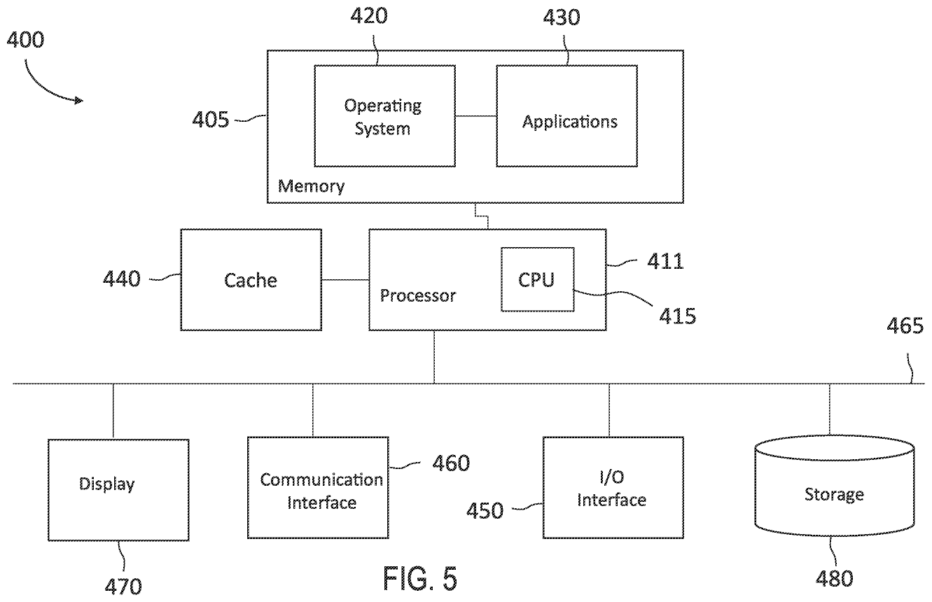

It should be appreciated that various concepts, systems and methods described above can be implemented in any number of ways, as the disclosed concepts are not limited to any particular manner of implementation or system configuration. Examples of specific implementations and applications are discussed below and shown in FIG. 5 primarily for illustrative purposes and for providing or describing the operating environment of the system of the present invention. The data collection and processing system 10 and/or any elements, components, or units thereof can employ one or more electronic or computing devices, such as one or more servers, clients, computers, laptops, smartphones and the like, that are networked together or which are arranged so as to effectively communicate with each other. The network (such as network 14) can be any type or form of network. The devices can be on the same network or on different networks. In some embodiments, the network system may include multiple, logically-grouped servers. In one of these embodiments, the logical group of servers may be referred to as a server farm or a machine farm. In another of these embodiments, the servers may be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, server nodes, or remote machines. In some embodiments, a client has the capacity to function as both a client or client node seeking access to resources provided by a server or server node and as a server providing access to hosted resources for other clients. The clients can be any suitable electronic or computing device, including for example, a computer, a server, a smartphone, a smart electronic pad, a portable computer, and the like, such as the electronic or computing device 400. The present invention can employ one or more of the illustrated computing devices and can form a computing system. Further, the server may be a file server, application server, web server, proxy server, appliance, network appliance, gateway, gateway server, virtualization server, deployment server, SSL VPN server, or firewall, or any other suitable electronic or computing device, such as the electronic device 400. In one embodiment, the server may be referred to as a remote machine or a node. In another embodiment, a plurality of nodes may be in the path between any two communicating servers or clients. The data collection and processing system 10 which includes for example the computing layer 18, the enrichment unit 22, the digital trust infrastructure unit 20, the post-processing unit 24, the data layer 30, the applications interface unit 32, and the cognitive intelligence unit 34 can be stored in or on or be implemented by one or more of the clients or servers, and the hardware associated with the client or server, such as the processor or CPU, memory, storage and the like described herein.

FIG. 5 is a high-level block diagram of an electronic or computing device 400 that can be used with the embodiments disclosed herein of the data collection and processing system 10 of the present invention. Without limitation, the hardware, software, and techniques described herein can be implemented in digital electronic circuitry or in computer hardware that executes firmware, software, or combinations thereof. The implementation can include a computer program product (e.g., a non-transitory computer program tangibly embodied in a machine-readable storage device, for execution by, or to control the operation of, one or more data processing apparatuses, such as a programmable processor, one or more computers, one or more servers and the like).

The illustrated electronic device 400 can be any suitable electronic circuitry that includes a main memory unit 405 that is connected to a processor 411 having a CPU 415 and a cache unit 440 configured to store copies of the data from the most frequently used main memory 405. The electronic device can implement the process flow identification system 10 or one or more elements of the process flow identification system.

Further, the methods and procedures for carrying out the methods disclosed herein can be performed by one or more programmable processors executing a computer program to perform functions of the invention by operating on input data and generating output. Further, the methods and procedures disclosed herein can also be performed by, and the apparatus disclosed herein can be implemented as, special purpose logic circuitry, such as a FPGA (field programmable gate array) or an ASIC (application specific integrated circuit). Modules and units disclosed herein can also refer to portions of the computer program and/or the processor/special circuitry that implements that functionality.

The processor 411 is any logic circuitry that responds to, processes or manipulates instructions received from the main memory unit, and can be any suitable processor for execution of a computer program. For example, the processor 411 can be a general and/or special purpose microprocessor and/or a processor of a digital computer. The CPU 415 can be any suitable processing unit known in the art. For example, the CPU 415 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, the processor can comprise at least one of a multi-core processor and a front-end processor. Generally, the processor 411 can be embodied in any suitable manner. For example, the processor 411 can be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. Additionally or alternatively, the processor 411 can be configured to execute instructions stored in the memory 405 or otherwise accessible to the processor 411. As such, whether configured by hardware or software methods, or by a combination thereof, the processor 411 can represent an entity (e.g., physically embodied in circuitry) capable of performing operations according to embodiments disclosed herein while configured accordingly. Thus, for example, when the processor 411 is embodied as an ASIC, FPGA or the like, the processor 411 can be specifically configured hardware for conducting the operations described herein. Alternatively, as another example, when the processor 411 is embodied as an executor of software instructions, the instructions can specifically configure the processor 411 to perform the operations described herein. In many embodiments, the central processing unit 530 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The processor can be configured to receive and execute instructions received from the main memory 405.

The electronic device 400 applicable to the hardware of the present invention can be based on any of these processors, or any other processor capable of operating as described herein. The central processing unit 415 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

The processor 411 and the CPU 415 can be configured to receive instructions and data from the main memory 405 (e.g., a read-only memory or a random access memory or both) and execute the instructions The instructions and other data can be stored in the main memory 405. The processor 411 and the main memory 405 can be included in or supplemented by special purpose logic circuitry. The main memory unit 405 can include one or more memory chips capable of storing data and allowing any storage location to be directly accessed by the processor 411. The main memory unit 405 may be volatile and faster than other memory in the electronic device, or can dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 405 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 405 can be based on any of the above described memory chips, or any other available memory chips capable of operating as described herein. In the embodiment shown in FIG. 5, the processor 411 communicates with main memory 405 via a system bus 465. The computer executable instructions of the present invention may be provided using any computer-readable media that is accessible by the computing or electronic device 400. Computer-readable media may include, for example, the computer memory or storage unit 405. The computer storage media may also include, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer readable storage media does not include communication media. Therefore, a computer storage or memory medium should not be interpreted to be a propagating signal per se or stated another transitory in nature. The propagated signals may be present in a computer storage media, but propagated signals per se are not examples of computer storage media, which is intended to be non-transitory. Although the computer memory or storage unit 405 is shown within the computing device 400 it will be appreciated that the storage may be distributed or located remotely and accessed via a network or other communication link.

The main memory 405 can comprise an operating system 420 that is configured to implement various operating system functions. For example, the operating system 420 can be responsible for controlling access to various devices, memory management, and/or implementing various functions of the asset management system disclosed herein. Generally, the operating system 420 can be any suitable system software that can manage computer hardware and software resources and provide common services for computer programs.

The main memory 405 can also hold application software 430. For example, the main memory 405 and application software 430 can include various computer executable instructions, application software, and data structures, such as computer executable instructions and data structures that implement various aspects of the embodiments described herein. For example, the main memory 405 and application software 430 can include computer executable instructions, application software, and data structures, such as computer executable instructions and data structures that implement various aspects of the content characterization systems disclosed herein, such as processing and capture of information. Generally, the functions performed by the content characterization systems disclosed herein can be implemented in digital electronic circuitry or in computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers). Generally, the program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

The processor 411 can further be coupled to a database or data storage 480. The data storage 480 can be configured to store information and data relating to various functions and operations of the content characterization systems disclosed herein. For example, as detailed above, the data storage 480 can store information including but not limited to captured information, multimedia, processed information, and characterized content.

A wide variety of I/O devices may be present in or connected to the electronic device 400. For example, the electronic device can include a display 470, and as previously described, the data collection and processing system 10 can include the display. The display 470 can be configured to display information and instructions received from the processor 411. Further, the display 470 can generally be any suitable display available in the art, for example a Liquid Crystal Display (LCD), a light emitting diode (LED) display, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays, or electronic papers (e-ink) displays. Furthermore, the display 470 can be a smart and/or touch sensitive display that can receive instructions from a user and forwarded the received information to the processor 411. The input devices can also include user selection devices, such as keyboards, mice, trackpads, trackballs, touchpads, touch mice, multi-touch touchpads, touch mice and the like, as well as microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices can also include video displays, graphical displays, speakers, headphones, inkjet printers, laser printers, and 3D printers.

The electronic device 400 can also include an Input/Output (I/O) interface 450 that is configured to connect the processor 411 to various interfaces via an input/output (I/O) device interface 480. The device 400 can also include a communications interface 460 that is responsible for providing the circuitry 400 with a connection to a communications network (e.g., communications network 120). Transmission and reception of data and instructions can occur over the communications network.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

We claim:

1. A data collection and processing system, comprising
a plurality of data sources for generating environmental data,
a data analysis module for receiving the environmental data from the plurality of data sources, wherein the data analysis module includes
an enrichment unit for storing and enriching the environmental data from the plurality of data sources to form enriched environmental data, wherein the enrichment unit includes a financial subsystem for analyzing and processing the environmental data and for generating financial data and non-financial data therefrom, and
a digital trust infrastructure unit for storing the financial data and the non-financial data, the enriched environmental data or the environmental data is stored in the data layer in a secure and verifiable format, wherein the digital trust infrastructure unit employs a blockchain for storing any combination of the environmental data, the enriched environmental data, and the financial data, and
a post-processing unit for processing the environmental data and the financial data stored in the digital trust infrastructure so as to generate one or more reports from the environmental data and the financial data,
wherein the data sources include a plurality of measuring devices coupled to one or more structures for measuring one or more selected parameters including one or more of power generation, power consumption, humidity, occupancy, and emissions of various fluids and gases, to form the environmental data, and pre-stored data including data from data libraries related to the parameters being measured by the measurement devices,
wherein the enrichment layer comprises
a data layer for storing the environmental data from the plurality of data sources,
an applications interface unit having an application unit for storing one or more software applications for processing the environmental data in the data layer, and a third party data unit for storing third party data that is related to the environmental data stored in the data layer, and
a cognitive intelligence unit for applying one or more pre-defined intelligence techniques to the environmental data so as to process and enrich the environmental data to form the enriched environmental data, wherein the cognitive intelligence unit includes a recommendation engine for applying a machine learning technique to the environmental data from the data layer to generate predictions based on the environmental data.

2. The data collection and processing system of claim 1, wherein the pre-defined intelligence techniques include one or more of a machine learning technique, an artificial intelligence technique, a natural language processing technique, neural networks, statistical techniques, and a risk modelling technique.

3. The data collection and processing system of claim 1, wherein the third party data comprises one or more of weather data, occupancy data, satellite data, optical data, physical enterprise data, maintenance related data, equipment related data, spatial related data associated with structures, enterprise data, and asset management related data.

4. The data collection and processing system of claim 1, further comprising a computing layer for storing the data from the plurality of data sources prior to storing the data in the data layer.

5. The data collection and processing system of claim 1, wherein the cognitive intelligence unit further comprises a risk model unit for applying one or more risk modelling techniques to the environmental data from the data layer.

6. The data collection and processing system of claim 5, wherein the risk model unit and the recommendation engine consume the enriched environmental data that is stored in the digital trust infrastructure unit, wherein the digital trust infrastructure unit employs a blockchain for storing the enriched environmental data.

7. The data collection and processing system of claim 6, wherein the post-processing unit includes one or more software applications for processing and integrating the enriched environmental data stored in the blockchain to generate one or more reports from the enriched environmental data.

8. The data collection and processing system 6, wherein the post-processing unit further comprises a data visualization software application for analyzing the enriched environmental data and then displaying the data in a graph-type visualization format.

9. The data collection and processing system of claim 1, further comprising a token creation unit for creating tokens from the environmental data collected from a plurality of measuring devices or the enriched environmental data or data provided by a third party to form one or more financial derivatives, wherein the financial derivatives can include one or more of a carbon credit, a renewable energy credit, an emissions reduction credit, and a carbon offset.

10. The data collection and processing system of claim 1, wherein the post-processing unit further comprises one or more of:
an emissions accounting unit for processing the enriched environmental data to provide one or more reports related to tracking and determining emissions of an enterprise,
an emissions management unit for processing the enriched environmental data to manage the emissions of the enterprise,
an emissions reporting unit for processing the enriched environmental data to generate one or more reports directed to an emissions profile of the enterprise,
an emissions trading unit for processing the enriched environmental data to provide information relating to trading of one or more emission related credits between enterprises,
a risk management unit for processing the enriched environmental data to determine and manage a financial risk or a non-financial risk to the enterprise based on the environmental data, and
a governance reporting unit for processing the enriched environmental data and generating based thereon a report directed to a governance profile of the enterprise.

11. The data collection and processing system of claim 10, wherein the emissions accounting unit determines the emissions of the enterprise or building or infrastructure and determines and tracks energy consumption of the enterprise based on the enriched environmental data.

12. The data collection and processing system of claim 11, wherein the emissions management unit determines overall energy consumption of the enterprise and based on the enriched environmental data procures energy and one or more other utilities including water for the enterprise.

13. The data collection and processing system of claim 10, wherein the emissions reporting unit generates one or more reports based on climate data and the enriched environmental data to certify the accuracy of the emissions of the enterprise based on the emissions determined by the emissions accounting unit, the overall energy consumption determined by the emissions management unit, and one or more tokens created by a token creation unit from the environmental data collected from a plurality of measuring devices.

14. The data collection and processing system of claim 13, wherein the emissions trading unit is configured to determine a carbon allowance associated with the enterprise and to track and certify any tokenized carbon credits or renewable energy certificates or emissions reduction credits associated with the emission offsets of the enterprise.

15. A computer-implemented method for collecting and processing data, comprising
generating environmental data from a plurality of data sources,
providing a data analysis module for receiving the environmental data from the plurality of data sources, wherein the data analysis module includes
an enrichment unit for storing and enriching the environmental data from the plurality of data sources, wherein the enrichment unit includes a financial subsystem for analyzing and processing the environmental data and for generating financial data therefrom, and
a digital trust infrastructure unit for storing the financial data, the enriched environmental data or the environmental data stored in the data layer in a secure and verifiable format, and
processing the environmental data and the financial data stored in the digital trust infrastructure with a post-processing unit so as to generate one or more reports from the environmental data and the financial data,
wherein the enrichment layer is configured for
storing the environmental data from the plurality of data sources in a data layer,
storing one or more software applications for processing the environmental data in the data layer in an application unit,
storing third party data that is related to the environmental data stored in the data layer in a third party data unit, and
applying one or more pre-defined techniques to the environmental data so as to process the environmental data in a cognitive intelligence unit.

16. The computer-implemented method of claim 15, wherein the pre-defined techniques include a machine learning technique, an artificial intelligence technique, or a risk modelling technique.

17. The computer-implemented method of claim 15, further comprising storing the data from the plurality of data sources prior to storing the data in the data layer in a computing layer.

18. The computer-implemented method of claim 15, wherein the digital trust infrastructure unit employs a blockchain technique for storing the data.

19. The computer-implemented method of claim 15, wherein the third party data includes maintenance related data, equipment related data, spatial related data associated with one or more structures, enterprise data, asset management related data, and weather related data.

20. The computer-implemented method of claim 15, further comprising a token creation unit for creating tokens from the environmental data collected from a plurality of measuring devices, from the enriched environmental data, or from the third party data.

21. The computer implemented method of claim 15, wherein the digital trust infrastructure unit is configured for storing the financial data, the environmental data, the enriched environmental data, and one or more of the pre-defined techniques.

22. The computer-implemented method of claim 15, wherein the post-processing unit further comprises one or more of:
an emissions accounting unit for processing the enriched environmental data to provide one or more reports related to tracking and determining emissions of an enterprise,
an emissions management unit for processing the enriched environmental data to manage the emissions of the enterprise,
an emissions reporting unit for processing the enriched environmental data to generate one or more reports directed to an emissions profile of the enterprise,
an emissions trading unit for processing the enriched environmental data to provide information or reports related to trading of one or more emission related credits between enterprises,
a risk management unit for processing the enriched environmental data to determine and manage a financial risk to the enterprise based on the environmental data, and
a governance reporting unit for processing the enriched environmental data and generating based thereon a report directed to a governance profile of the enterprise.
